(19) United States
(12) Patent Application Publication
(10) Pub. No.: US 2026/0302806 A1
(43) Pub. Date: Oct. 1, 2026

(54) POWER CONVERTER

(71) Applicant: APh ePower Co., Ltd., Kaohsiung City (TW)

(72) Inventors: Hsiu-Hsien Su, Kaohsiung City (TW); Shang-Zeng Huang, Kaohsiung City (TW); Yu-Chi Lin, Kaohsiung City (TW); Te-Chun Hung, Kaohsiung City (TW)

(73) Assignee: APh ePower Co., Ltd., Kaohsiung City (TW)

(21) Appl. No.: 19/467,688

(22) Filed: Feb. 2, 2026

(30) Foreign Application Priority Data
Mar. 28, 2025 (TW) 114112048

(51) Int. Cl. H02J 7/56; H02J 50/10

(52) U.S. Cl. CPC H02J 7/56; H02J 50/10; H02J 2207/20

(57) ABSTRACT

A power converter is provided. The power converter includes a main power circuit, a load circuit, a transmission circuit, and an energy storage circuit. The main power circuit converts a main power into a transmission power. The load circuit converts the transmission power into a load power. The transmission circuit includes a master coil and a slave coil. The main coil is connected between the main power circuit and the load circuit. The slave coil generates an inductive power supply by inductive coupling according to the transmission power located in the master coil. The energy storage circuit is connected to the slave coil. The energy storage circuit receive the inductive power and is charged by using the inductive power.

### CROSS-REFERENCE TO RELATED APPLICATION

This application claims the priority benefit of Taiwan application serial no. 114112048, filed on Mar. 28, 2025. The entirety of the above-mentioned patent application is hereby incorporated by reference herein and made a part of this specification.

### BACKGROUND

### Technical Field

The disclosure relates to an electronic device, and in particular to a power converter.

### Related Art

Generally, a power converter may provide power of a power grid to a load. When the power converter is connected to the power grid, the load, and an energy storage circuit (for example, a battery module), the power of the power grid may be provided to one of the load and the energy storage circuit. It should be noted that, for example, when a voltage value of the load is lower than a voltage value of the energy storage circuit, the power of the power grid and the power of the energy storage circuit may naturally flow to the load. The energy storage circuit is forced to execute a discharge operation. Therefore, an energy storage effect of the energy storage circuit is reduced. For another example, when the voltage value of the energy storage circuit is lower than the voltage value of the load, the power of the power grid naturally flows to the energy storage circuit. Therefore, the power supply amount of the power converter to the load may be reduced.

Thereby, it may be known that if applied between the power grid, the load, and the energy storage circuit, the power converter needs to have diverse power conversion mechanisms.

### SUMMARY

The disclosure provides a power converter with diverse power conversion mechanisms.

A power converter of the disclosure includes a main power circuit, a load circuit, a transmission circuit, and at least one energy storage circuit. The main power circuit converts the main power to the transmission power. The load circuit converts the transmission power to the load power. The transmission circuit includes a master coil and at least one slave coil. The master coil is connected between the main power circuit and the load circuit. Each of the at least one slave coil to generates an inductive power by inductive coupling according to the transmission power located in the master coil. The at least one energy storage circuit is connected to the at least one slave coil in a one-to-one manner. The at least one energy storage circuit respectively receives the inductive power and to is charged by the inductive power.

Based on the above, the load circuit receives the transmission power, and converts the transmission power to the load power. The energy storage circuits respectively receive the inductive power in the slave coils and are charged by the inductive power. The power converter supplies power to the load circuit and the energy storage circuits with different power conversion mechanisms. In this way, the power supply of the power converter may not be interfered by the voltage of the load and the voltage located in the energy storage circuits.

### BRIEF DESCRIPTION OF THE DRAWINGS

FIG. 1 is a schematic diagram of a power converter according to an embodiment of the disclosure.

FIG. 2 is a schematic circuit diagram of a power converter according to an embodiment of the disclosure.

FIGS. 3A and 3B are schematic operation diagrams of a power converter according to an embodiment of the disclosure.

FIGS. 4A and 4B are schematic operation diagrams of a power converter according to an embodiment of the disclosure.

FIGS. 5A and 5B are schematic operation diagrams of a power converter according to an embodiment of the disclosure.

FIGS. 6A and 6B are schematic operation diagrams of a power converter according to an embodiment of the disclosure.

FIGS. 7A and 7B are schematic operation diagrams of a power converter according to an embodiment of the disclosure.

FIGS. 8A and 8B are schematic operation diagrams of a power converter according to an embodiment of the disclosure.

FIGS. 9A and 9B are schematic operation diagrams of a power converter according to an embodiment of the disclosure.

FIGS. 10A and 10B are schematic operation diagrams of a power converter according to an embodiment of the disclosure.

FIGS. 11A and 11B are schematic operation diagrams of a power converter according to an embodiment of the disclosure.

FIGS. 12A and 12B are schematic operation diagrams of a power converter according to an embodiment of the disclosure.

FIGS. 13A and 13B are schematic operation diagrams of a power converter according to an embodiment of the disclosure.

FIGS. 14A and 14B are schematic operation diagrams of a power converter according to an embodiment of the disclosure.

FIGS. 15A and 15B are schematic operation diagrams of a power converter according to an embodiment of the disclosure.

FIGS. 16A and 16B are schematic operation diagrams of a power converter according to an embodiment of the disclosure.

FIGS. 17A and 17B are schematic operation diagrams of a power converter according to an embodiment of the disclosure.

### DESCRIPTION OF THE EMBODIMENTS

Some embodiments of the disclosure are described in detail with reference to the accompanying drawings. When the same reference numerals appear in different drawings, the reference numerals in the following description shall be regarded as the same or similar elements. The embodiments are only a part of the disclosure and do not disclose all possible implementations of the disclosure. More specifically, the embodiments are merely examples within the scope of the patent application of the disclosure.

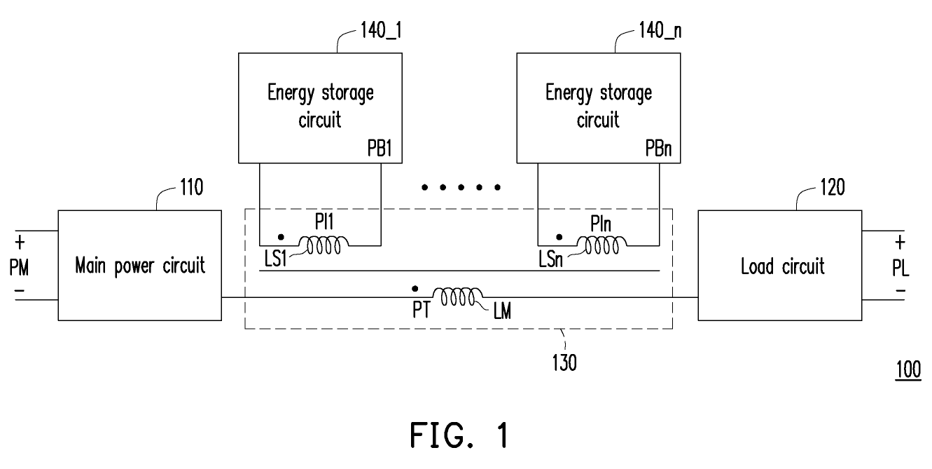

Referring to FIG. 1, FIG. 1 is a schematic diagram of a power converter according to an embodiment of the disclosure. In this embodiment, a power converter 100 includes a main power circuit 110, a load circuit 120, a transmission circuit 130, and energy storage circuits 140_1 to 140_n. The main power circuit 110 converts a main power PM into a transmission power PT. The load circuit 120 converts the transmission power PT into a load power PL. The transmission circuit 130 includes a master coil LM and slave coils LS1 to LSn. The master coil LM is connected between the main power circuit 110 and the load circuit 120. “n” may be a positive integer greater than 1.

In this embodiment, the slave coils LS1 to LSn respectively generate an inductive power supply by inductive coupling according to the transmission power PT located in the master coil LM. For example, the slave coil LS1 generates an inductive power PI1 by inductive coupling. Similarly, the slave coil LSn generates an inductive power PIn by inductive coupling. In this embodiment, the energy storage circuits 140_1 to 140_n are connected to the slave coils LS1 to LSn in a one-to-one manner. For example, the energy storage circuit 140_1 is connected to the slave coil LS1. The energy storage circuit 140_1 receives the inductive power PI1 and is charged by the inductive power PI1. Similarly, the energy storage circuit 140_n is connected to the slave coil LSn. The energy storage circuit 140_n receives the inductive power PIn and is charged by the inductive power PIn.

It is worth mentioning that the load circuit 120 receives the transmission power PT and converts the transmission power PT into the load power PL. The energy storage circuits 140_1 to 140_n respectively receive corresponding inductive powers located in corresponding slave coils and are charged by the corresponding inductive powers. Therefore, the power converter 100 supplies power to the load circuit 120 and the energy storage circuits 140_1 to 140_n with different power conversion mechanisms. In this way, the power supply of the power converter 100 may not be interfered by the voltage of the load and the voltages located in the energy storage circuits 140_1 to 140_n.

In this embodiment, the main power PM and the load power PL may be direct current power sources respectively, but the disclosure is not limited thereto.

In this embodiment, the main power circuit 110 converts the main power PM into the transmission power PT. The main power circuit 110 provides the transmission power PT to the master coil LM. The load circuit 120 receives the transmission power PT located in the master coil LM and converts the transmission power PT into the load power PL. At this time, the slave coils LS1 to LSn respectively generate the inductive powers PI1 to PIn by inductive coupling according to the transmission power PT located in the master coil LM. Therefore, the energy storage circuits 140_1 to 140_n may be charged by the inductive powers PI1 to PIn. In other words, the power converter 100 may charge the energy storage circuits 140_1 to 140_n by the main power PM.

In this embodiment, the load power PL may be a redundant power. For example, the load power PL may be a power generated by back electromotive force generated by a motor. The motor is, for example, a motor used for an electric vehicle or an elevator. The load circuit 120 receives the load power PL, converts the load power PL into the transmission power PT, and provides the transmission power PT to the master coil LM. The main power circuit 110 receives the transmission power PT located in the master coil LM and converts the transmission power PT into the main power PM. Therefore, the power converter 100 may feed back the energy of the load power PL to the main power PM. At this time, the slave coils LS1 to LSn respectively generate the inductive powers PI1 to PIn by inductive coupling according to the transmission power PT located in the master coil LM. Therefore, the energy storage circuits 140_1 to 140_n may be charged by the inductive powers PI1 to PIn. In other words, the power converter 100 may charge the energy storage circuits 140_1 to 140_n by the load power PL.

In this embodiment, the energy storage circuits 140_1 to 140_n may supply power. For example, the energy storage circuit 140_1 may provide a battery power PB1. Similarly, the energy storage circuit 140_n may provide a battery power PBn. The energy storage circuits 140_1 to 140_n may respectively provide the battery powers PB1 to PBn to the corresponding slave coils. Therefore, the slave coil LS1 receives the battery power PB1. Similarly, the slave coil LSn receives the battery power PBn. The transmission circuit 130 generates the transmission power PT located in the master coil LM by inductive coupling according to the battery powers PB1 to PBn.

The main power circuit 110 receives the transmission power PT located in the master coil LM and converts the transmission power PT into the main power PM. At this time, the load circuit 120 may also receive the transmission power PT located in the master coil LM and convert the transmission power PT into the load power PL. In other words, the power converter 100 may generate at least one of the main power PM and the load power PL by the battery powers PB1 to PBn.

In some embodiments, the power converter 100 may include a single energy storage circuit 140_1. The disclosure is not limited by the number of energy storage circuits.

Based on the above, the power converter 100 may provide diverse power conversion mechanisms.

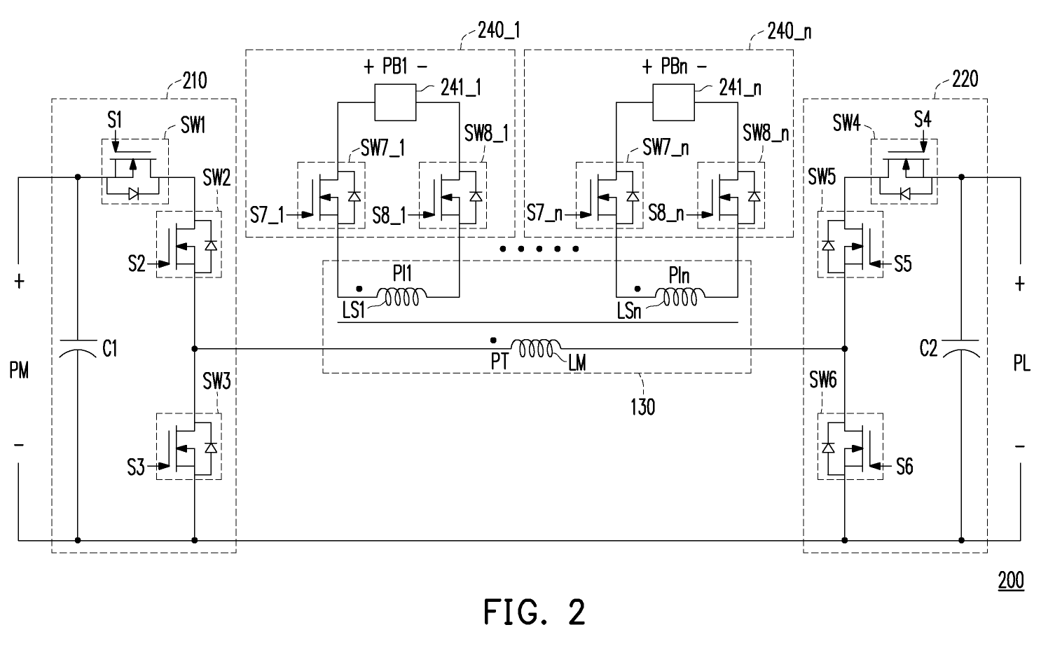

Referring to FIG. 2, FIG. 2 is a schematic circuit diagram of a power converter according to an embodiment of the disclosure. In this embodiment, a power converter 200 includes a main power circuit 210, a load circuit 220, a transmission circuit 130, and energy storage circuits 240_1 to 240_n. The main power circuit 210 includes a capacitor C1 and power switches SW1 TO SW3. The capacitor C1 is connected between a positive power terminal and a negative power terminal. A first terminal of the power switch SW1 is connected to the positive power terminal. A control terminal of the power switch SW1 receives a switch signal S1. A first terminal of the power switch SW2 is connected to a first terminal of the master coil LM. A second terminal of the power switch SW2 is connected to a second terminal of the power switch SW1. A control terminal of the power switch SW2 receives a switch signal S2. A first terminal of the power switch SW3 is connected to the negative power terminal. A second terminal of the power switch SW3 is connected to the first terminal of the power switch SW2. A control terminal of the power switch SW3 receives a switch signal S3.

The load circuit 220 includes a capacitor C2 and power switches SW4 TO SW6. The capacitor C2 is connected between a positive load terminal and a negative load terminal. A first terminal of the power switch SW4 is connected to the positive load terminal. A control terminal of the power switch SW4 receives a switch signal S4. A first terminal of the power switch SW5 is connected to a second terminal of the master coil LM. A second terminal of the power switch SW5 is connected to a second terminal of the power switch SW4. A control terminal of the power switch SW5 receives a switch signal S5. A first terminal of the power switch SW6 is connected to the negative load terminal. A second terminal of the power switch SW6 is connected to the first terminal of the power switch SW5. A control terminal of the power switch SW6 receives a switch signal S6.

It should be noted that the circuit configurations of the main power circuit 210 and the load circuit 220 are symmetrical to each other based on the transmission circuit 130. Therefore, the complexity of the circuit design of the power converter 200 may be reduced.

The energy storage circuit 240_1 includes a battery 241_1 and power switches SW7_1, SW8_1. A first terminal of the power switch SW7_1 is connected to a first terminal of the slave coil LS1. A second terminal of the power switch SW7_1 is connected to a positive terminal of the battery 241_1. A control terminal of the power switch SW7_1 receives a switch signal S7_1. A first terminal of the power switch SW8_1 is connected to a second terminal of the slave coil LS1. A second terminal of the power switch SW8_1 is connected to a negative terminal of the battery 241_1. A control terminal of the power switch SW8_1 receives a switch signal S8_1.

The energy storage circuit 240_n includes a battery 241_n and power switches SW7_n, SW8_n. A first terminal of the power switch SW7_n is connected to a first terminal of the slave coil LSn. A second terminal of the power switch SW7_n is connected to a positive terminal of the battery 241_n. A control terminal of the power switch SW7_n receives a switch signal S7_n. A first terminal of the power switch SW8_n is connected to a second terminal of the slave coil LSn. A second terminal of the power switch SW8_n is connected to a negative terminal of the battery 241_n. A control terminal of the power switch SW8_n receives a switch signal S8_n.

In this embodiment, the power switches SW1 TO SW6, SW7_1 to SW7_n, SW8_1 to SW8_n respectively include a transistor and a diode. A first terminal of the transistor is connected to a first terminal of the corresponding power switch. A second terminal of the transistor is connected to a second terminal of the corresponding power switch. A control terminal of the transistor is connected to a control terminal of the corresponding power switch. The transistor is, for example, implemented by an N-type transistor. An anode of the diode is connected to the first terminal of the corresponding power switch. A cathode of the diode is connected to the second terminal of the corresponding power switch.

In this embodiment, the switch signals S1 TO S6, S7_1 to S7_n, S8_1 to S8_n are respectively provided by a control circuit CC. The control circuit CC may make the power converter 200 enter different power conversion modes by the switch signals S1 TO S6, S7_1 to S7_n, S8_1 to S8_n. The switch signals S1 TO S6, S7_1 to S7_n, S8_1 to S8_n may be pulse width modulation (PWM) signals. The duty cycles of the switch signals S1 TO S6, S7_1 to S7_n, S8_1 to S8_n are greater than or equal to 0 and less than or equal to 100.

The batteries 241_1 to 241_n are, for example, respectively implemented by aluminum-ion batteries, but the disclosure is not limited to the implementation of the batteries. In some embodiments, the batteries 241_1 to 241_n are, for example, respectively implemented by lithium-ion batteries.

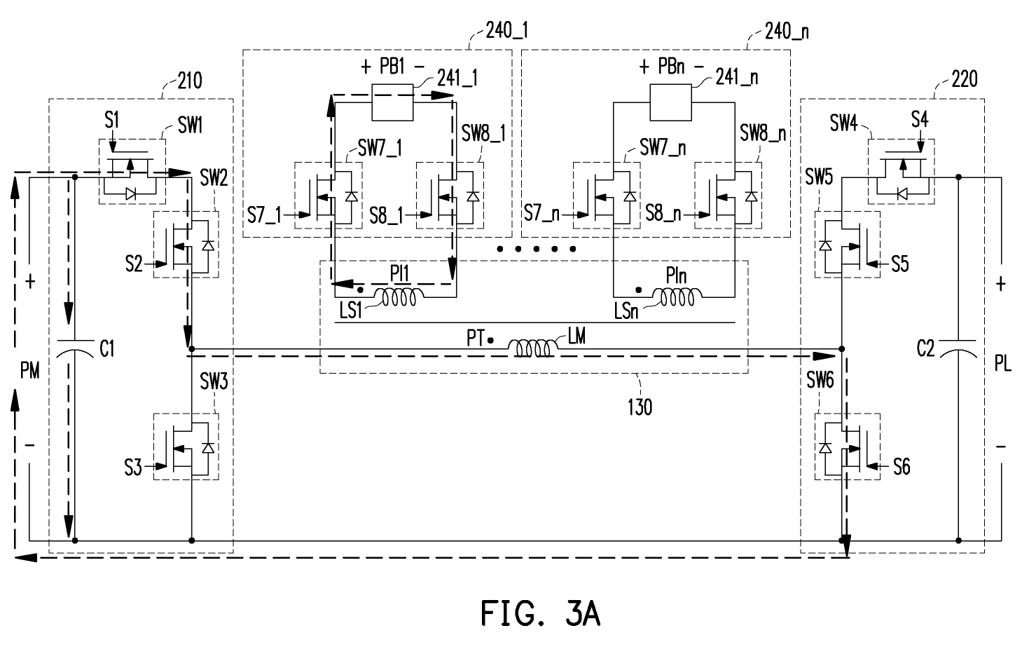

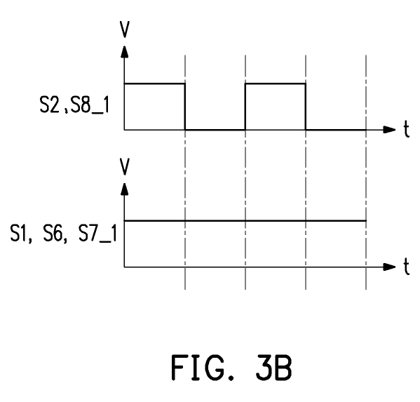

Referring to FIGS. 3A and 3B, FIGS. 3A and 3B are schematic operation diagrams of a power converter according to an embodiment of the disclosure. In this embodiment, when the power converter 200 charges the battery 241_1 by the main power PM, the power switches SW1, SW2, SW6 jointly form a primary-side circuit connected to the master coil LM. The master coil LM and the slave coil LS1 jointly form a transformer. The power switches SW7_1, SW8_1 jointly form a secondary-side circuit connected to the slave coil LS1.

For example, in response to the high voltage levels of the switch signals S1, S6, S7_1, the power switches SW1, SW6, SW7_1 are continuously conducted. In response to the duty cycles of the switch signals S2, S8_1, the power switches SW2, SW8_1 execute switching operations. The remaining power switches are continuously disconnected by the low voltage levels of the received switch signals. Therefore, an electrical energy flow path of the power converter 200 is as shown by the dashed arrows in FIG. 3A.

It should be noted that the power converter 200 may adjust the charging power of the battery 241_1 by the duty cycles of the switch signals S2, S8_1 according to the adjusted voltage value of the battery power PB1 of the battery 241_1. For example, when the voltage value of the battery power PB1 is lower than a cutoff voltage value, the duty cycle of the switch signal S8_1 is higher, and the charging power of the battery 241_1 becomes higher. Therefore, the charging speed of the battery 241_1 is also faster. The duty cycle of the switch signal S8_1 is lower, so the charging power of the battery 241_1 becomes lower. The charging speed of the battery 241_1 is also slower.

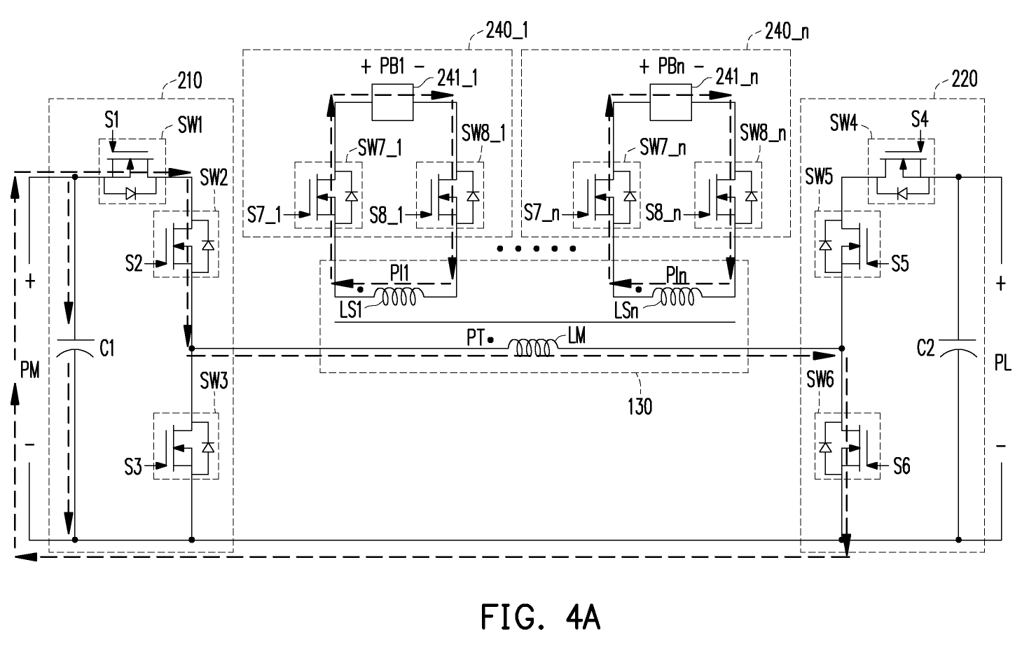

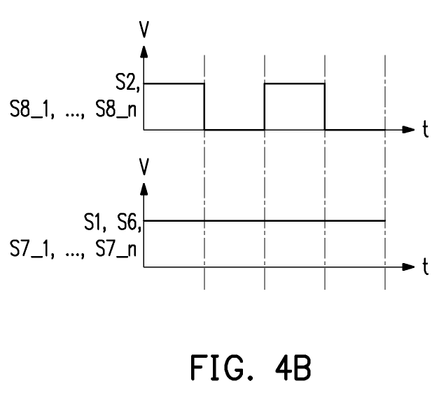

Referring to FIGS. 4A and 4B, FIGS. 4A and 4B are schematic operation diagrams of a power converter according to an embodiment of the disclosure. In this embodiment, when the power converter 200 charges the batteries 241_1 to 241_n by the main power PM, the power switches SW1, SW2, SW6 jointly form a primary-side circuit connected to the master coil LM. The master coil LM and the slave coil LS1 jointly form a transformer. The power switches SW7_1, SW8_1 jointly form a secondary-side circuit connected to the slave coil LS1. Similarly, the power switches SW7_n, SW8_n jointly form a secondary-side circuit connected to the slave coil LSn.

For example, in response to the high voltage levels of the switch signals S1, S6, S7_1 to S7_n, the power switches SW1, SW6, SW7_1 to SW7_n are continuously conducted. In response to the duty cycles of the switch signals S2, S8_1 to S8_n, the power switches SW2, SW8_1 to SW8_n execute switching operations. The remaining power switches are continuously disconnected by the low voltage levels of the received switch signals. Therefore, the electrical energy flow path of the power converter 200 is as shown by the dashed arrows in FIG. 4A.

It should be noted that the power converter 200 may adjust the charging power of the batteries 241_1 to 241_n by the duty cycles of the switch signals S8_1 to S8_n according to the adjusted voltage values of the battery powers PB1 to PBn of the batteries 241_1 to 241_n.

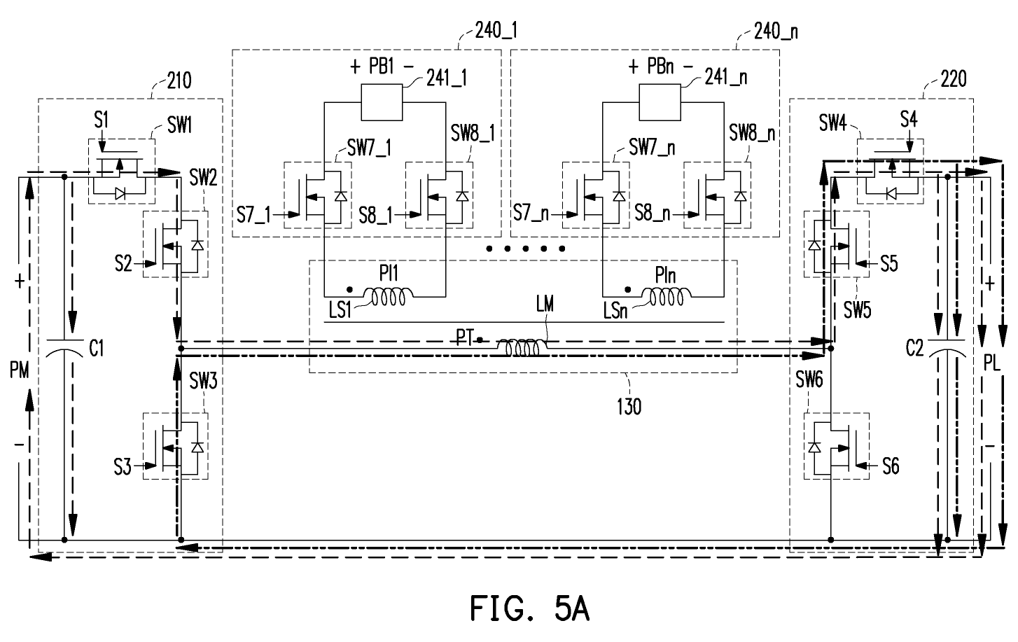

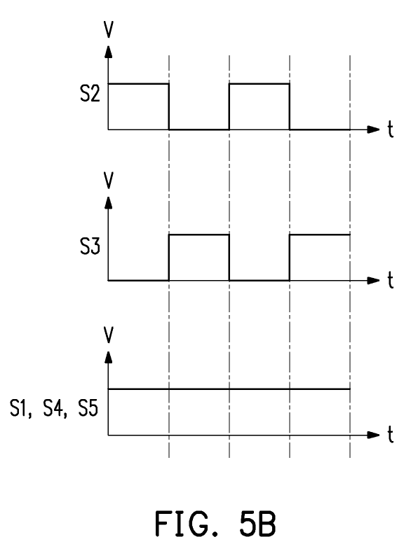

Referring to FIGS. 5A and 5B, FIGS. 5A and 5B are schematic operation diagrams of a power converter according to an embodiment of the disclosure. In this embodiment, when the power converter 200 converts the main power PM to the load power PL, the power switches SW1 TO SW5 and the master coil LM jointly form a buck circuit. The voltage value of the main power PM is higher than the voltage value of the load power PL. In response to the high voltage levels of the switch signals S1, S4, S5, the power switches SW1, SW4, SW5 are continuously conducted. In response to the duty cycles of the switch signals S2, S3, the power switches SW2, SW3 execute switching operations. The power switches SW2, SW3 are not conducted simultaneously. The remaining power switches are continuously disconnected by the low voltage levels of the received switch signals. Therefore, the electrical energy flow path of the power converter 200 is as shown by the dashed arrows in FIG. 5A.

It should be noted that the power converter 200 may adjust the voltage value or voltage power of the load power PL by the duty cycles of the switch signals S2, S3. For example, the duty cycles of the switch signals S2, S3 are higher, so the voltage value of the load power PL becomes higher. The duty cycles of the switch signals S2, S3 are lower, so the voltage value of the load power PL becomes lower.

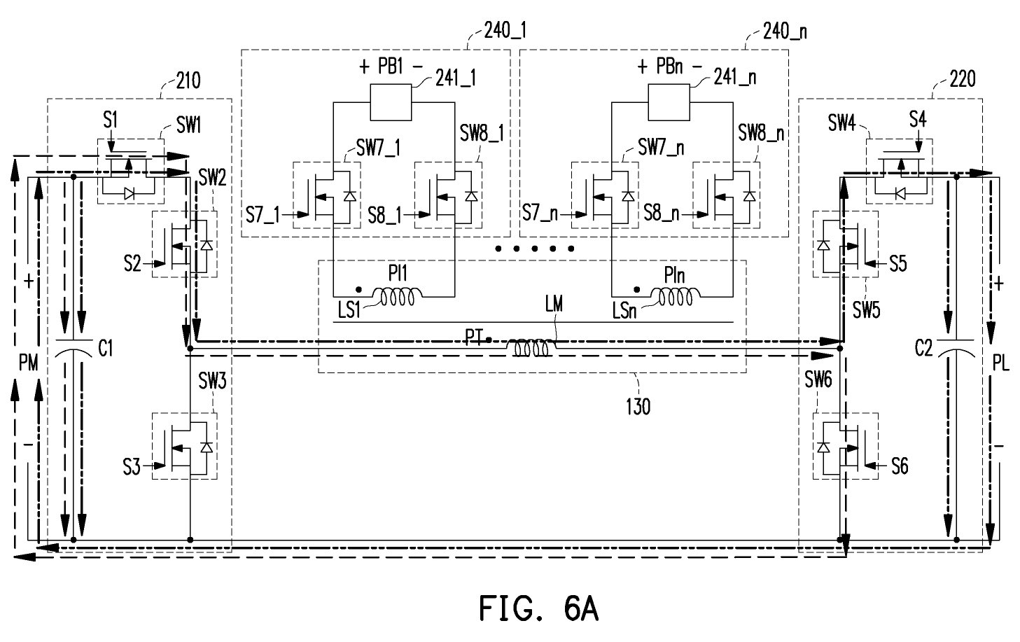

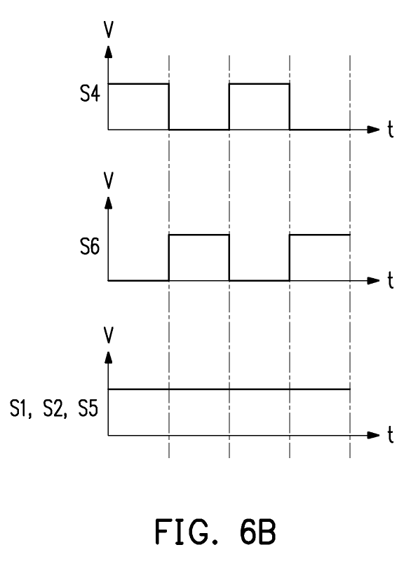

Referring to FIGS. 6A and 6B, FIGS. 6A and 6B are schematic operation diagrams of a power converter according to an embodiment of the disclosure. In this embodiment, when the power converter 200 converts the main power PM to the load power PL, the power switches SW1, SW2, SW4 TO SW6 and the master coil LM jointly form a boost circuit. The voltage value of the main power PM is lower than the voltage value of the load power PL. In response to the high voltage levels of the switch signals S1, S2, S5, the power switches SW1, SW2, SW5 are continuously conducted. In response to the duty cycles of the switch signals S4, S6, the power switches SW4, SW6 execute switching operations. The power switches SW4, SW6 are not conducted simultaneously. The remaining power switches are continuously disconnected by the low voltage levels of the received switch signals. Therefore, the electrical energy flow path of the power converter 200 is as shown by the dashed arrows in FIG. 6A.

It should be noted that the power converter 200 may adjust the voltage value or power of the load power PL by the duty cycles of the switch signals S4, S6. For example, the duty cycles of the switch signals S4, S6 are higher, so the voltage value of the load power PL becomes higher. The duty cycles of the switch signals S4, S6 are lower, so the voltage value of the load power PL becomes lower.

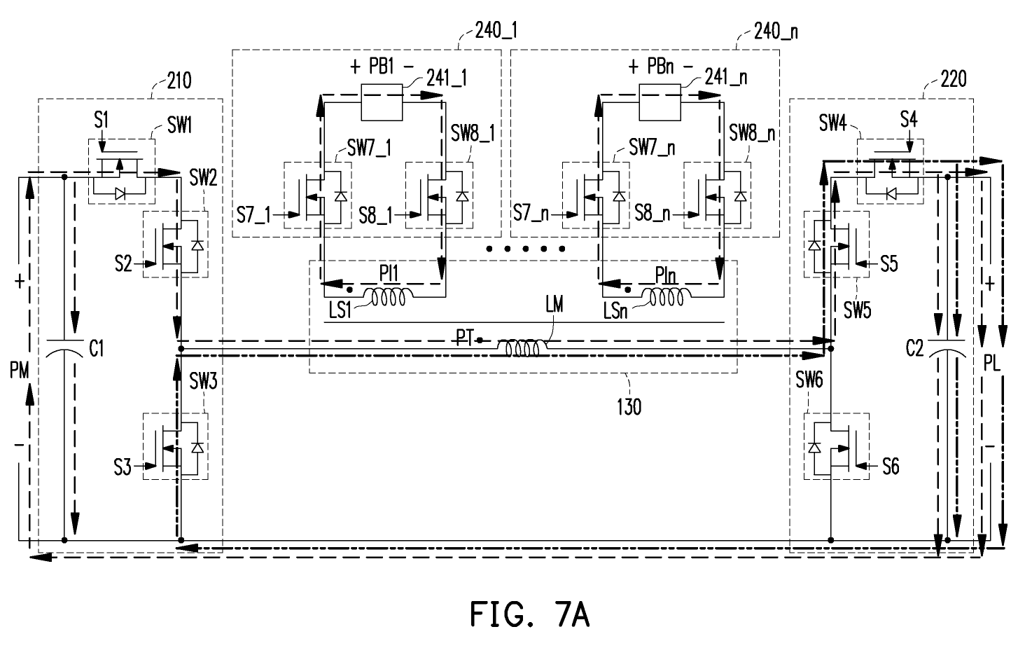

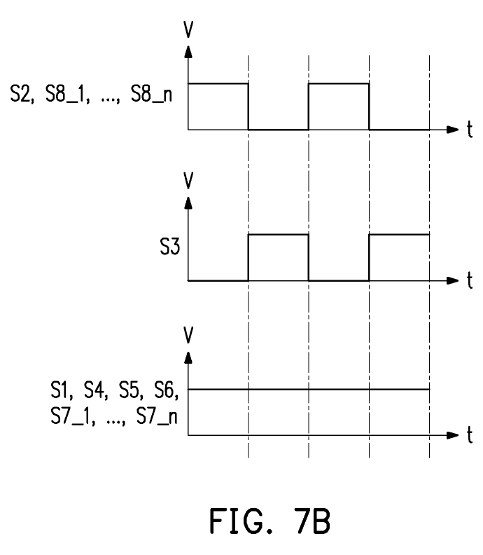

Referring to FIGS. 7A and 7B, FIGS. 7A and 7B are schematic operation diagrams of a power converter according to an embodiment of the disclosure. In this embodiment, when the power converter 200 converts the main power PM to the load power PL and charges the batteries 241_1 to 241_n by the main power PM, the power switches SW1 TO SW5 and the master coil LM jointly form a buck circuit. The power switches SW7_1, SW8_1 jointly form a secondary-side circuit connected to the slave coil LS1. Furthermore, the power switches SW7_n, SW8_n jointly form a secondary-side circuit connected to the slave coil LSn. The implementation details of the secondary-side circuit and the buck circuit have been clearly described in the embodiments of FIGS. 4A, 4B, 5A and 5B respectively. The electrical energy flow path of the power converter 200 is as shown by the dashed arrows in FIG. 7A.

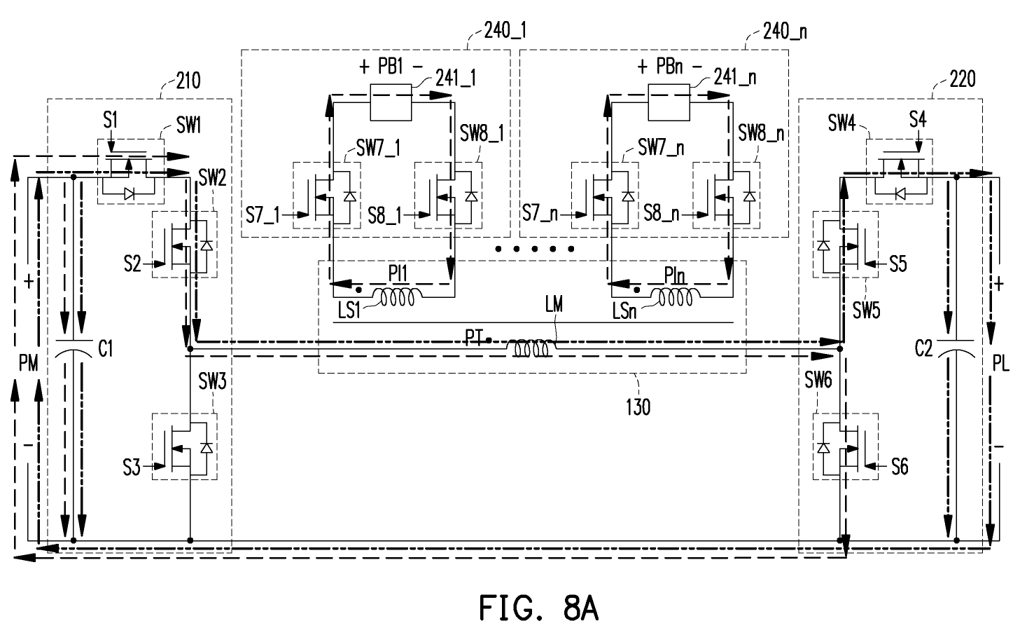

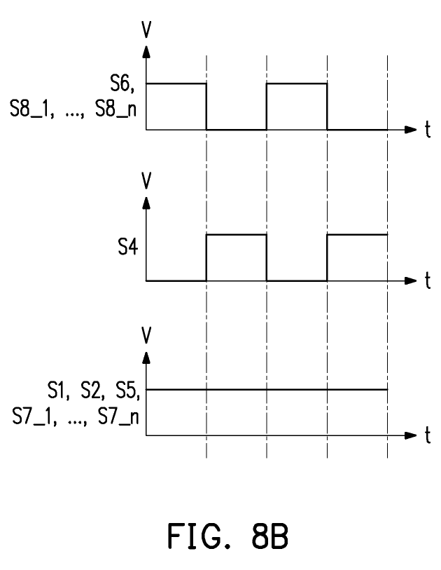

Referring to FIGS. 8A and 8B, FIGS. 8A and 8B are schematic operation diagrams of a power converter according to an embodiment of the disclosure. In this embodiment, when the power converter 200 converts the main power PM to the load power PL and charges the batteries 241_1 to 241_n by the main power PM, the power switches SW1, SW2, SW4 TO SW6 and the master coil LM jointly form a boost circuit. The power switches SW7_1, SW8_1 jointly form a secondary-side circuit connected to the slave coil LS1. Furthermore, the power switches SW7_n, SW8_n jointly form a secondary-side circuit connected to the slave coil LSn. The implementation details of the secondary-side circuit and the boost circuit have been clearly described in the embodiments of FIGS. 4A, 4B, 6A and 6B respectively, and thus are not repeated here. The electrical energy flow path of the power converter 200 is as shown by the dashed arrows in FIG. 8A.

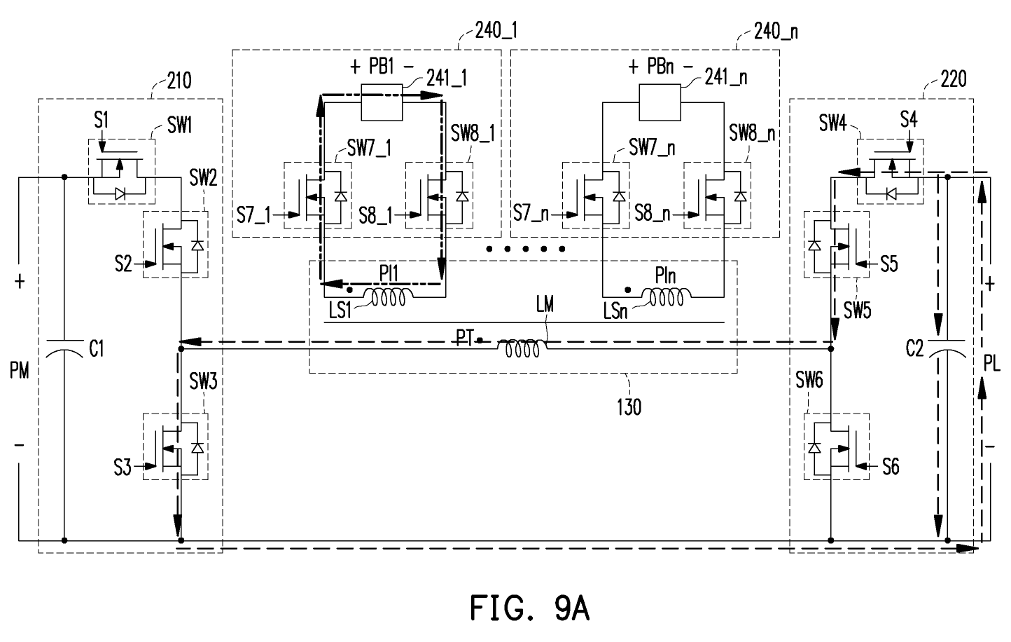

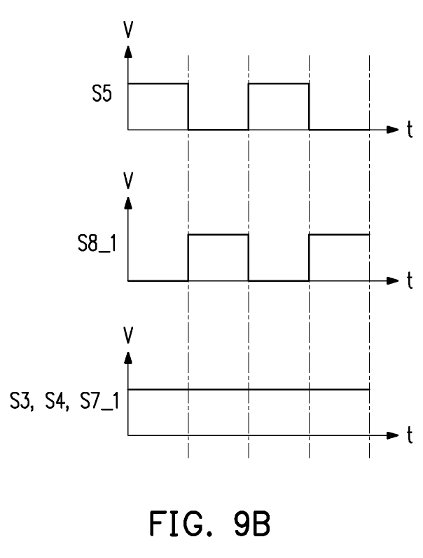

Referring to FIGS. 9A and 9B, FIGS. 9A and 9B are operation diagrams of a power converter according to an embodiment of the disclosure. In this embodiment, when the power converter 200 charges the battery 241_1 by the load power PL, the power switches SW3 TO SW5 jointly form a primary-side circuit connected to the master coil LM. The master coil LM and the slave coil LS1 jointly form a transformer. The power switches SW7_1, SW8_1 jointly form a secondary-side circuit connected to the slave coil LS1.

For example, in response to the high voltage levels of the switch signals S3, S4, S7_1, the power switches SW3, SW4, SW7_1 are continuously conducted. In response to the duty cycles of the switch signals S5, S8_1, the power switches SW5, SW8_1 execute switching operations. The power switches SW5, SW8_1 are not conducted simultaneously. The remaining power switches are continuously disconnected by the low voltage levels of the received switch signals. Therefore, the electrical energy flow path of the power converter 200 is as shown by the dashed arrows in FIG. 9A.

The power converter 200 may adjust the charging power of the battery 241_1 by the duty cycles of the switch signals S5, S8_1 according to the adjusted voltage value of the battery power PB1 of the battery 241_1. For example, when the voltage value of the battery power PB1 is lower than the cutoff voltage value, the duty cycles of the switch signals S5, S8_1 are higher, and the charging power of the battery 241_1 becomes higher. Therefore, the charging speed of the battery 241_1 is also faster. The duty cycles of the switch signals S5, S8_1 are lower, so the charging power of the battery 241_1 becomes lower. The charging speed of the battery 241_1 is also slower.

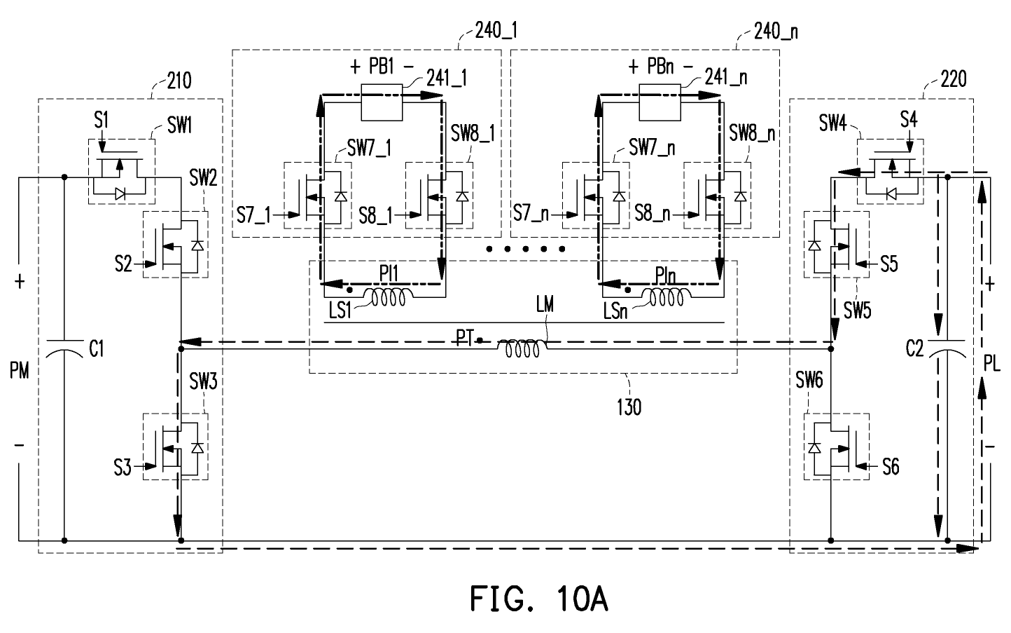

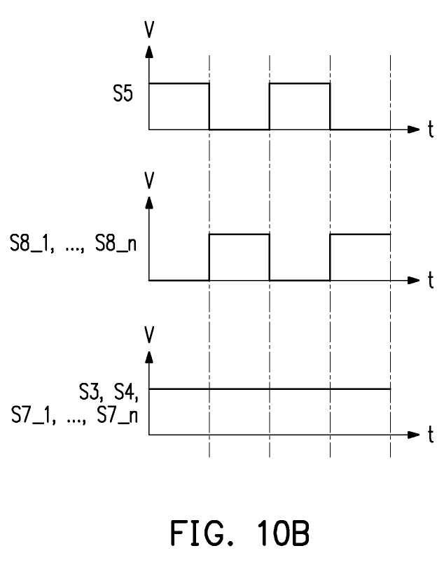

Referring to FIGS. 10A and 10B, FIGS. 10A and 10B are schematic operation diagrams of a power converter according to an embodiment of the disclosure. In this embodiment, when the power converter 200 charges the batteries 241_1 to 241_n by the load power PL, the power switches SW3 TO SW5 jointly form a primary-side circuit connected to the master coil LM. The master coil LM and the slave coil LS1 jointly form a transformer. The power switches SW7_1, SW8_1 jointly form a secondary-side circuit connected to the slave coil LS1. Similarly, the power switches SW7_n, SW8_n jointly form a secondary-side circuit connected to the slave coil LSn.

For example, in response to the high voltage levels of the switch signals S3, S5, S7_1 to S7_n, the power switches SW3, SW5, SW7_1 to SW7_n are continuously conducted. In response to the duty cycles of the switch signals S5, S8_1 to S8_n, the power switches SW5, SW8_1 to SW8_n execute switching operations. The remaining power switches are continuously disconnected by the low voltage levels of the received switch signals. Therefore, the electrical energy flow path of the power converter 200 is as shown by the dashed arrows in FIG. 10A.

It should be noted that the power converter 200 may adjust the charging power of the batteries 241_1 to 241_n by the duty cycles of the switch signals S5, S8_1 to S8_n according to the adjusted voltage value of the battery power PB1 of the battery 241_1.

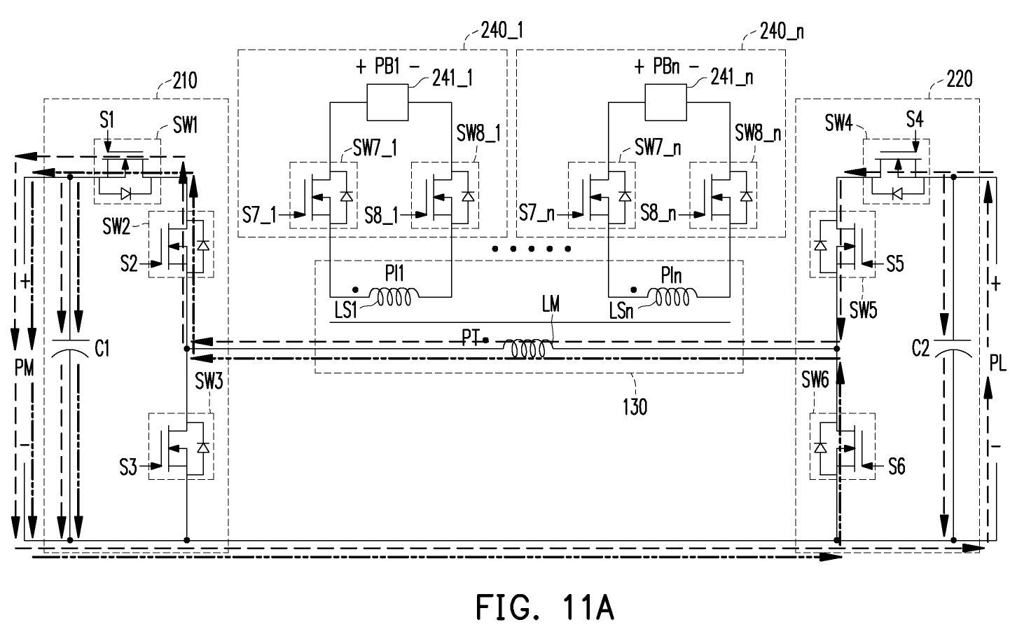

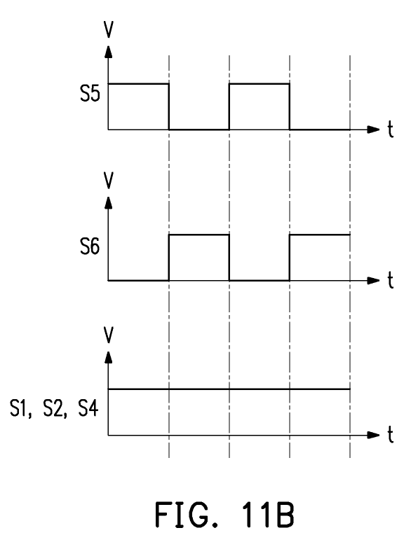

Referring to FIGS. 11A and 11B, FIGS. 11A and 11B are schematic operation diagrams of a power converter according to an embodiment of the disclosure. In this embodiment, when the power converter 200 converts the load power PL to the main power PM, the first power switches SW1, SW2, SW4 TO SW6 and the master coil LM jointly form a buck circuit. The voltage value of the load power PL is higher than the voltage value of the main power PM.

For example, in response to the high voltage levels of the switch signals S1, S2, S4, the power switches SW1, SW2, SW4 are continuously conducted. In response to the duty cycles of the switch signals S5, S6, the power switches SW5, SW6 execute switching operations. The power switches SW5, SW6 are not conducted simultaneously. The remaining power switches are continuously disconnected by the low voltage levels of the received switch signals. Therefore, the electrical energy flow path of the power converter 200 is as shown by the dashed arrows in FIG. 11A.

It should be noted that the power converter 200 may adjust the power of the main power PM by the duty cycles of the switch signals S5, S6. For example, the duty cycles of the switch signals S5, S6 are higher, so the voltage value of the main power PM becomes higher. The duty cycles of the switch signals S5, S6 are lower, so the voltage value of the main power PM becomes lower.

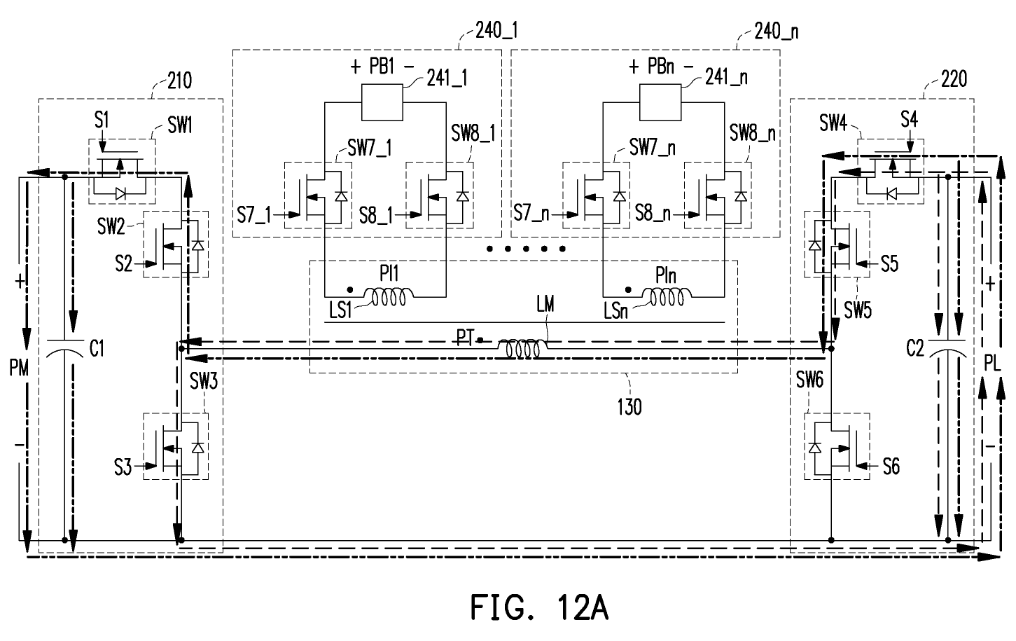

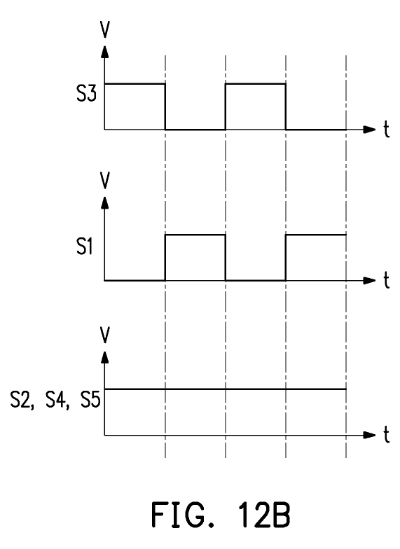

Referring to FIGS. 12A and 12B, FIGS. 12A and 12B are schematic operation diagrams of a power converter according to an embodiment of the disclosure. In this embodiment, when the power converter 200 converts the load power PL to the main power PM, the power switches SW1 TO SW5 and the master coil LM jointly form a boost circuit. The voltage value of the load power PL is lower than the voltage value of the main power PM.

For example, in response to the high voltage levels of the switch signals S2, S4, S5, the power switches SW2, SW4, SW5 are continuously conducted. In response to the duty cycles of the switch signals S1, S3, the power switches SW1, SW3 execute switching operations. The power switches SW1, SW3 are not conducted simultaneously. The remaining power switches are continuously disconnected by the low voltage levels of the received switch signals. Therefore, the electrical energy flow path of the power converter 200 is as shown by the dashed arrows in FIG. 12A.

It should be noted that the power converter 200 may adjust the power of the main power PM by the duty cycles of the switch signals S1, S3. For example, the duty cycles of the switch signals S1, S3 are higher, so the voltage value of the main power PM becomes higher. The duty cycles of the switch signals S1, S3 are lower, so the voltage value of the main power PM becomes lower.

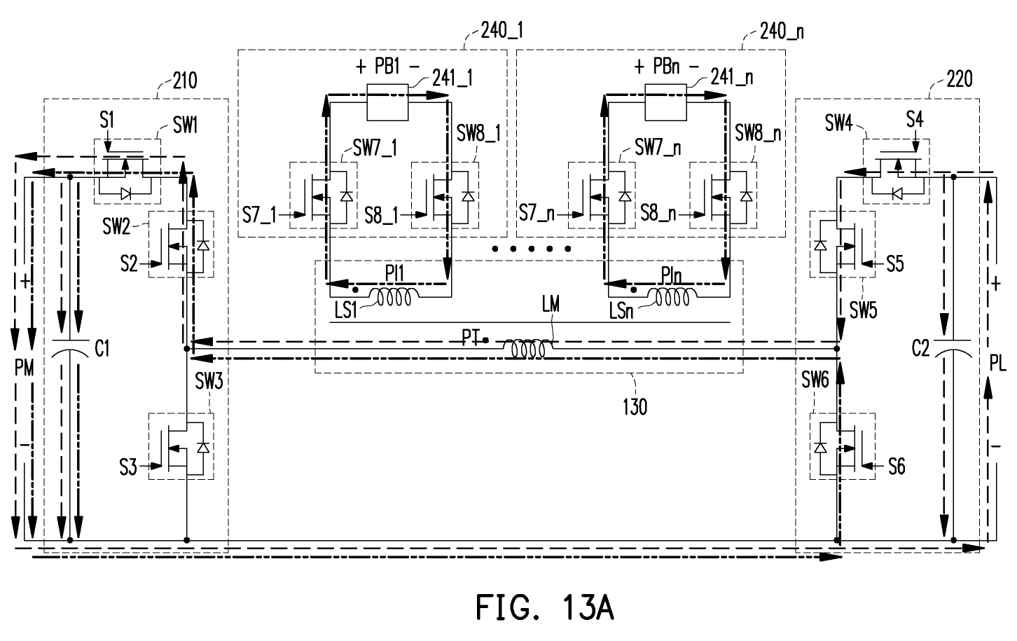

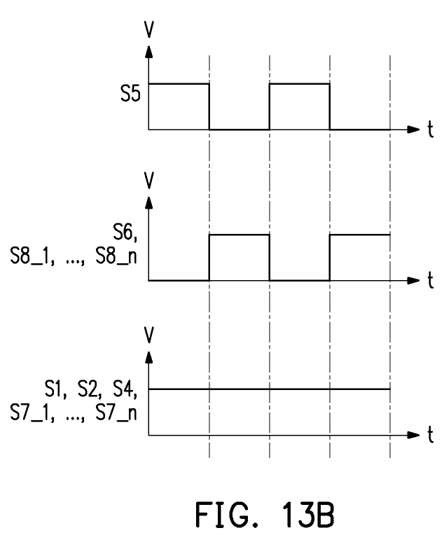

Referring to FIGS. 13A and 13B, FIGS. 13A and 13B are schematic operation diagrams of a power converter according to an embodiment of the disclosure. In this embodiment, when the power converter 200 converts the load power PL to the main power PM and charges the batteries 241_1 to 241_n by the load power PL, the first power switches SW1, SW2, SW4 TO SW6 and the master coil LM jointly form a buck circuit. The power switches SW7_1, SW8_1 jointly form a secondary-side circuit connected to the slave coil LS1. In addition, the power switches SW7_n, SW8_n jointly form a secondary-side circuit connected to the slave coil LSn. The implementation details of the secondary-side circuit and the buck circuit have been clearly described in the embodiments of FIGS. 10A, 10B, 11A and 11B respectively. The electrical energy flow path of the power converter 200 is as shown by the dashed arrows in FIG. 13A.

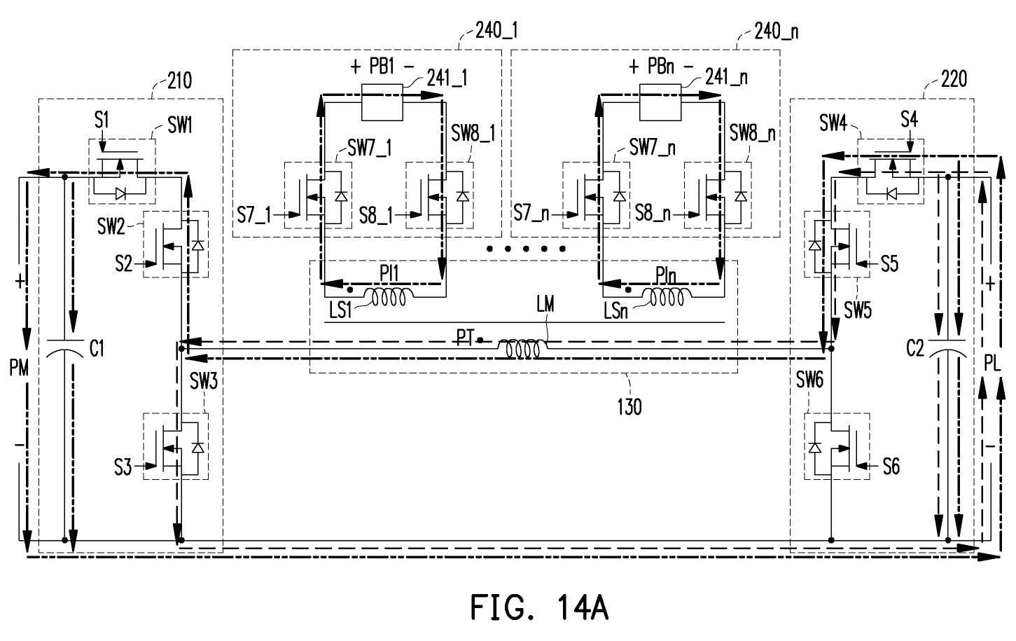

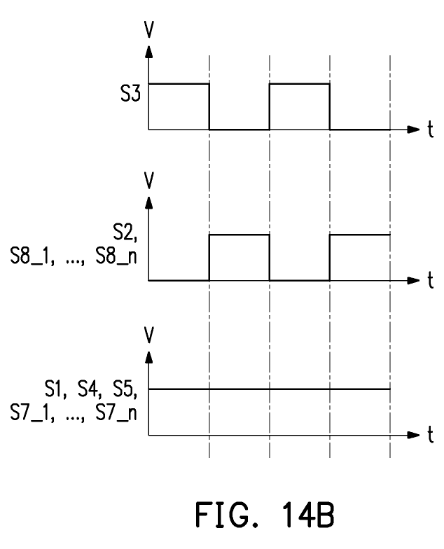

Referring to FIGS. 14A and 14B, FIGS. 14A and 14B are schematic operation diagrams of a power converter according to an embodiment of the disclosure. In this embodiment, when the power converter 200 converts the load power PL to the main power PM and charges the batteries 241_1 to 241_n by the load power PL, the power switches SW1 TO SW5 and the master coil LM jointly form a boost circuit. The power switches SW7_1, SW8_1 jointly form a secondary-side circuit connected to the slave coil LS1. In addition, the power switches SW7_n, SW8_n jointly form a secondary-side circuit connected to the slave coil LSn. The implementation details of the secondary-side circuit and the boost circuit have been clearly described in the embodiments of FIGS. 10A, 10B, 12A and 12B, respectively, and thus are not repeated here. The electrical energy flow path of the power converter 200 is as shown by the dashed arrows in FIG. 14A.

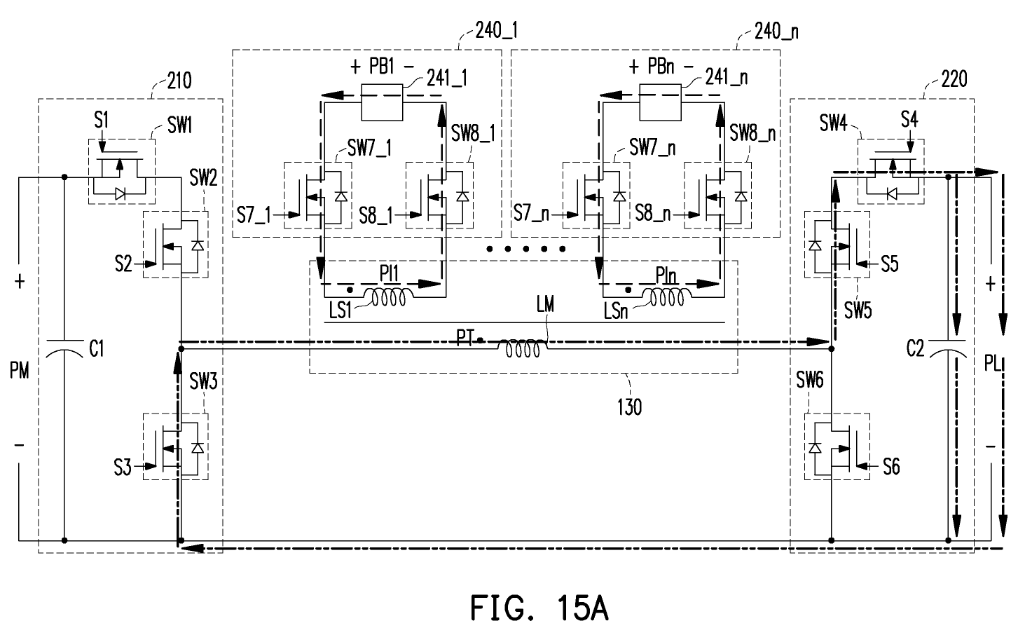

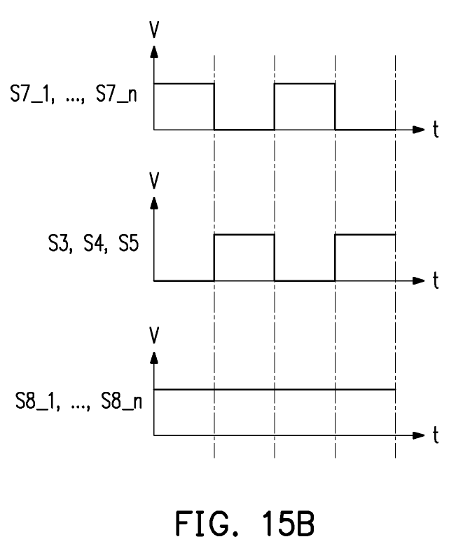

Referring to FIGS. 15A and 15B, FIGS. 15A and 15B are schematic operation diagrams of a power converter according to an embodiment of the disclosure. In this embodiment, when the power converter 200 converts the battery powers PB1 to PBn to the load power PL, the power switches SW7_1, SW8_1 jointly form a primary-side circuit connected to the slave coil LS1. Similarly, the power switches SW7_n, SW8_n jointly form a primary-side circuit connected to the slave coil LSn. The master coil LM and the slave coil LS1 jointly form a transformer. In addition, the power switches SW3 TO SW5 jointly form a secondary-side circuit connected to the master coil LM.

For example, in response to the high voltage level of the switch signals S8_1 to S8_n, the power switches SW8_1 to SW8_n are continuously conducted. In response to the duty cycle of the switch signals S3 TO S5, S7_1 to S7_n, the power switches SW3 TO SW5, SW7_1 to SW7_n S3 TO S5 execute switching operations. The remaining power switches are continuously disconnected by the low voltage levels of the received switch signals. Therefore, the electrical energy flow path of the power converter 200 is as shown by the dashed arrows in FIG. 15A.

It should be noted that the power converter 200 may adjust the duty cycles of the switch signals S7_1 to S7_n according to the current voltage or current states of charges (SOCs) of the battery powers PB1 to PBn. Taking the battery 241_1 as an example, the current voltage or current SOC of the battery power PB1 being higher indicates that the battery 241_1 has higher power. The switch signalS7_1 may have a higher duty cycle. The output power of the battery power PB1 is higher. Therefore, the power of the inductive power PI1 located in the slave coil LS1 is also higher. Taking the battery 241_n as an example, the current voltage or current SOC of the battery power PBn being too low indicates that the battery power PBn is determined to be insufficient for power supply. Therefore, the duty cycle of the switch signal S7_n equals 0. The battery power PBn is not output. Therefore, the power of the inductive power PIn located in the slave coil LSn equals 0.

In addition, the power converter 200 may adjust the duty cycles of the switch signals S3 TO S5, S7_1 to S7_n according to the required power of the load circuit 220. For example, when the required power of the load circuit 220 is lower, the duty cycle of at least one of the switch signals S3 TO S5, S7_1 toS7_n may be reduced. For example, when the required power of the load circuit 220 is higher, the duty cycle of the switch signals S3 TO S5, S7_1 to S7_n may be increased.

Based on the above, the power converter 200 may appropriately adjust the output of the battery powers PB1 to PBn according to the current voltages or current SOCs of the battery powers PB1 to PBn or the required power of the load circuit 220. In this way, the service lifespan of the batteries 241_1 to 241_n may be enhanced.

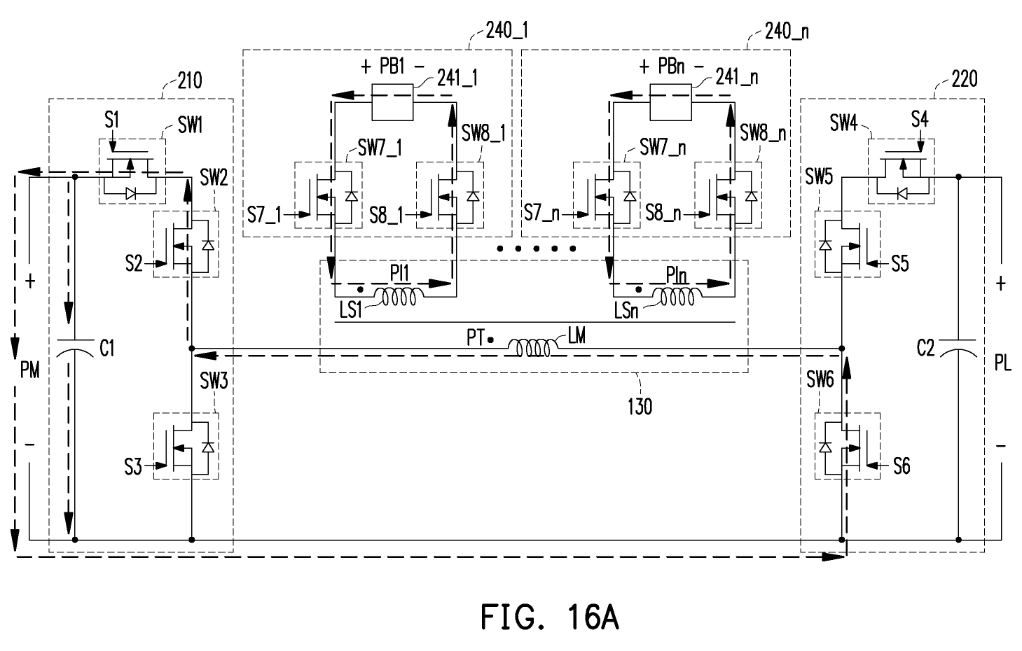

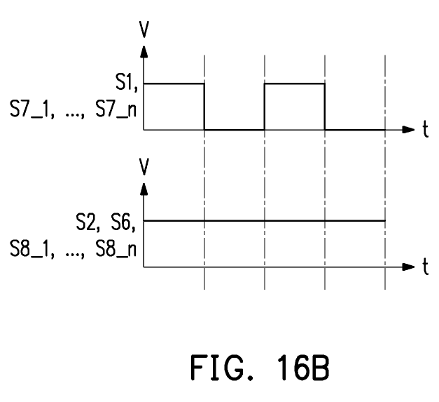

Referring to FIGS. 16A and 16B, FIGS. 16A and 16B are schematic operation diagrams of a power converter according to an embodiment of the disclosure. In this embodiment, when the power converter 200 converts the battery powers PB1 to PBn to the main power PM, the power switches SW7_1, SW8_1 jointly form a primary-side circuit connected to the slave coil LS1. Similarly, the power switches SW7_n, SW8_n jointly form a primary-side circuit connected to the slave coil LSn. The master coil LM and the slave coil LS1 jointly form a transformer. In addition, the power switches SW1, SW2, SW6 jointly form a secondary-side circuit connected to the master coil LM.

For example, in response to the high voltage levels of the switch signals S2, S6, S8_1 to S8_n, the power switches SW2, SW6, SW8_1 to SW8_n are continuously conducted. In response to the duty cycles of the switch signals S1, S7_1 to S7_n, the power switches SW1, SW7_1 to SW7_n execute switching operations. The remaining power switches are continuously disconnected by the low voltage levels of the received switch signals. Therefore, the electrical energy flow path of the power converter 200 is as shown by the dashed arrows in FIG. 16A.

It should be noted that the power converter 200 may adjust the duty cycles of the switch signals S7_1 to S7_n according to the current voltages or current SOCs of the battery powers PB1 to PBn. Taking the battery 241_1 as an example, the current voltage or current SOC of the battery power PB1 being higher indicates that the power level of the battery 241_1 is higher. The switch signal S7_1 may have a higher duty cycle. The output power of the battery power PB1 is higher. Therefore, the inductive power PI1 located in the slave coil LS1 also has higher power. Taking the battery 241_n as an example, the current voltage or current SOC of the battery power PBn being too low indicates that the battery power PBn is determined to be insufficient for power supply. Therefore, the duty cycle of the switch signal S7_n equals 0. The battery power PBn is not output. Therefore, the power of the inductive power PIn located in the slave coil LSn equals 0.

In addition, the power converter 200 may adjust the duty cycles of the switch signals S1, S7_1 to S7_n according to the feedback power of the main power PM. For example, when the demand power of the load circuit 220 is lower, the duty cycles of at least one of the switch signals S1, S7_1 to S7_n may be reduced. For example, when the demand power of the load circuit 220 is higher, the duty cycles of the power switches S1, S7_1 to S7_n may be increased.

Based on the above, the power converter 200 may appropriately adjust the output of the battery powers PB1 to PBn according to the current voltages or current SOCs of the battery powers PB1 to PBn or the feedback power of the main power PM. In this way, the service lifespan of the batteries 241_1 to 241_n may be enhanced.

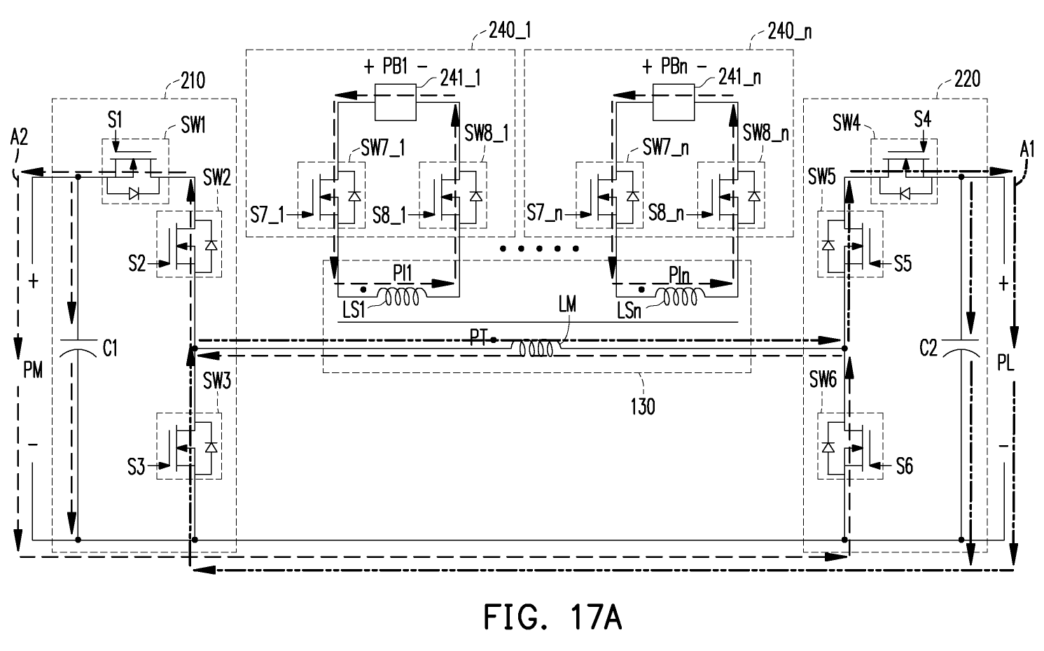

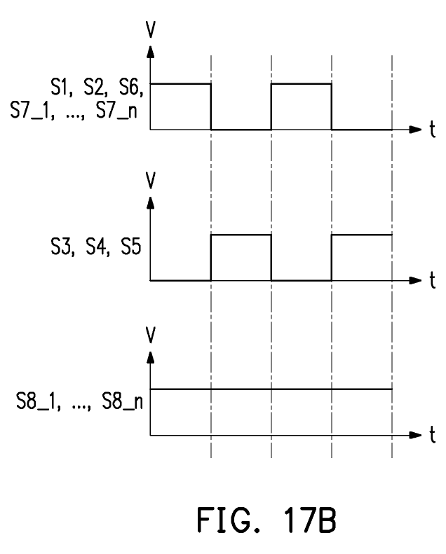

Referring to FIGS. 17A and 17B, FIGS. 17A and 17B are schematic operation diagrams of a power converter according to an embodiment of the disclosure. In this embodiment, the power converter 200 converts the battery powers PB1 to PBn to the main power PM and the load power PL. The power switches SW7_1, SW8_1 jointly form a primary-side circuit connected to the slave coil LS1. Similarly, the power switches SW7_n, SW8_n jointly form a primary-side circuit connected to the slave coil LSn. The master coil LM and the slave coil LS1 jointly form a transformer.

In addition, the power switches SW3 TO SW5 jointly form a first secondary-side circuit connected to the master coil LM. The power switches SW1, SW2, SW6 jointly form a second secondary-side circuit connected to the master coil LM.

In this embodiment, the power switches SW3 TO SW5 are conducted during a first period. The power switches SW1, SW2, SW6 are conducted during a second period. The first period and the second period do not overlap.

For example, in response to the high voltage level of the switch signals S8_1 to S8_n, the power switches SW8_1 to SW8_n are continuously conducted. In response to the duty cycles of the switch signals S7_1 to S7_n, the power switches SW7_1 to SW7_n execute switching operations. The power switches SW3 TO SW5 of the first secondary-side circuit may execute a first switching operation according to the duty cycles of the switch signals S3 TO S5. The operation of the first secondary-side circuit and the operation of the primary-side circuit are similar to the operations of FIGS. 15A and 15B. Therefore, the electrical energy flow path of the first secondary-side circuit during the first period is shown as a dashed arrow A1.

The power switches SW1, SW2, SW6 of the second secondary-side circuit may execute a second switching operation according to the duty cycle of the switch signals S1, S2, S6. The operation of the second secondary-side circuit and the operation of the primary-side circuit are similar to the operations of FIGS. 16A and 16B. Therefore, the electrical energy flow path of the second secondary-side circuit during the second period is shown as a dashed arrow A2.

In this embodiment, the power converter 200 may adjust the duty cycles of the switch signals S7_1 to S7_n according to the current voltages or current SOCs of the battery powers PB1 to PBn.

The power converter 200 may adjust the duty cycles of the switch signals S3 TO S5, S7_1 to S7_n according to the required power of the load circuit 220. For example, when the required power of the load circuit 220 is lower, the duty cycle of at least one of the switch signals S3 TO S5, S7_1 to S7_n may be reduced. For example, when the required power of the load circuit 220 is higher, the duty cycles of the switch signals S3 TO S5, S7_1 to S7_n may be increased.

The power converter 200 may adjust the duty cycles of the switch signals S1, S2, S6, S7_1 to S7_n according to the feedback power of the main power PM. For example, when the required power of the load circuit 220 is lower, the duty cycles of at least one of the switch signals S1, S2, S6, S7_1 to S7_n may be reduced. For example, when the required power of the load circuit 220 is higher, the duty cycles of the switch signals S1, S2, S6, S7_1 to S7_n may be increased.

In summary, the load circuit receives transmission power, and converts the transmission power to the load power. The energy storage circuits respectively receive the inductive power located in the slave coil and are charged by the inductive power. The power converter supplies power to the load circuit and the energy storage circuits with different power conversion mechanisms. In this way, the power supply of the power converter may not be interfered by the voltage of the load and the voltage located in the energy storage circuits. In some embodiments, the power converter may convert the battery power of the energy storage circuit to at least one of the load power and the main power. In some embodiments, the power converter may convert the main power to at least one of the load power and the battery power. In some embodiments, the power converter may convert the load power to at least one of the main power and the battery power. Therefore, the power converter may provide diverse power conversion functions.

Although the present disclosure has been disclosed in the above embodiments, it is not intended to limit the present disclosure, and those skilled in the art can make some modifications and refinements without departing from the spirit and scope of the disclosure. Therefore, the scope of the present disclosure is subject to the definition of the scope of the appended claims.

What is claimed is:

1. A power converter, comprising:
a main power circuit, configured to convert a main power into a transmission power;
a load circuit, configured to convert the transmission power into a load power;
a transmission circuit, comprising:
a master coil, connected between the main power circuit and the load circuit; and
at least one slave coil, each configured to generate an inductive power by inductive coupling according to the transmission power located in the master coil; and
at least one energy storage circuit, connected to the at least one slave coil in a one-to-one manner, and respectively configured to receive the inductive power and be charged by the inductive power.

2. The power converter according to claim 1, wherein:
the main power circuit provides the transmission power to the master coil, and
the load circuit receives the transmission power located in the master coil, and converts the transmission power into the load power.

3. The power converter according to claim 1, wherein:
the load circuit converts the load power into the transmission power, and provides the transmission power to the master coil, and
the main power circuit receives the transmission power located in the master coil, and converts the transmission power into the main power.

4. The power converter according to claim 1, wherein:
each of the at least one energy storage circuit provides a battery power to a corresponding slave coil, and
the transmission circuit generates the transmission power in the master coil by the inductive coupling according to the battery power.

5. The power converter according to claim 4, wherein the main power circuit receives the transmission power located in the master coil, and converts the transmission power into the main power.

6. The power converter according to claim 4, wherein the load circuit receives the transmission power located in the master coil, and converts the transmission power into the load power.

7. The power converter according to claim 1, wherein the main power circuit comprises:
a first capacitor, connected between a positive power terminal and a negative power terminal;
a first power switch, having a first terminal of the first power switch connected to the positive power terminal, and having a control terminal of the first power switch to receive a first switch signal;
a second power switch, having a first terminal of the second power switch connected to a first terminal of the master coil, having a second terminal of the second power switch connected to a second terminal of the first power switch, and having a control terminal of the second power switch to receive a second switch signal; and
a third power switch, having a first terminal of the third power switch connected to the negative power terminal, having a second terminal of the third power switch connected to the first terminal of the second power switch, and having a control terminal of the third power switch to receive a third switch signal.

8. The power converter according to claim 7, wherein the load circuit comprises:
a second capacitor, connected between a positive load terminal and a negative load terminal;
a fourth power switch, having a first terminal of the fourth power switch connected to the positive load terminal, and having a control terminal of the fourth power switch to receive a fourth switch signal;
a fifth power switch, having a first terminal of the fifth power switch connected to a second terminal of the master coil, having a second terminal of the fifth power switch connected to a second terminal of the fourth power switch, and having a control terminal of the fifth power switch to receive a fifth switch signal; and
a sixth power switch, having a first terminal of the sixth power switch connected to the negative load terminal, having a second terminal of the sixth power switch connected to the first terminal of the fifth power switch, and having a control terminal of the sixth power switch to receive a sixth switch signal.

9. The power converter according to claim 8, wherein when the main power is converted into the load power, the first power switch, the second power switch, the third power switch, the fourth power switch, the fifth power switch, and the master coil jointly form a buck circuit.

10. The power converter according to claim 8, wherein when the main power is converted into the load power, the first power switch, the second power switch, the fourth power switch, the fifth power switch, the sixth power switch, and the master coil jointly form a boost circuit.

11. The power converter according to claim 8, wherein when the load power is converted into the main power, the first power switch, the second power switch, the fourth power switch, the fifth power switch, the sixth power switch, and the master coil jointly form a buck circuit.

12. The power converter according to claim 8, wherein when the load power is converted into the main power, the first power switch, the second power switch, the third power switch, the fourth power switch, the fifth power switch, and the master coil jointly form a boost circuit.

13. The power converter according to claim 8, wherein the first switch signal, the second switch signal, the third switch signal, the fourth switch signal, the fifth switch signal, and the sixth switch signal are pulse width modulation signals respectively.

14. The power converter according to claim 8, wherein a first energy storage circuit among the at least one energy storage circuit comprises:
a battery, configured to store a battery power;
a seventh power switch, having a first terminal of the seventh power switch connected to a first terminal of a first slave coil among the at least one slave coil, having a second terminal of the seventh power switch connected to a positive terminal of the battery, and having a control terminal of the seventh power switch to receive a seventh switch signal; and
an eighth power switch, having a first terminal of the eighth power switch connected to a second terminal of the first slave coil, having a second terminal of the eighth power switch connected to a negative terminal of the battery, and having a control terminal of the eighth power switch to receive an eighth switch signal.

15. The power converter according to claim 14, wherein when charging the battery by the main power:
the first power switch, the second power switch, and the sixth power switch jointly form a primary-side circuit connected to the master coil,
the master coil and the first slave coil jointly form a transformer, and
the seventh power switch and the eighth power switch jointly form a secondary-side circuit connected to the first slave coil.

16. The power converter according to claim 14, wherein when charging the battery by the load power:
the third power switch, the fourth power switch, and the fifth power switch jointly form a primary-side circuit connected to the master coil,
the master coil and the first slave coil jointly form a transformer, and
the seventh power switch and the eighth power switch jointly form a secondary-side circuit connected to the first slave coil.

17. The power converter according to claim 14, wherein when converting the battery power to the load power:
the seventh power switch and the eighth power switch jointly form a primary-side circuit connected to the first slave coil,
the master coil and the first slave coil jointly form a transformer, and
the third power switch, the fourth power switch, and the fifth power switch jointly form a secondary-side circuit connected to the master coil.

18. The power converter according to claim 14, wherein when converting the battery power to the main power:
the seventh power switch and the eighth power switch jointly form a primary-side circuit connected to the first slave coil,
the master coil and the first slave coil jointly form a transformer, and
the first power switch, the second power switch, and the sixth power switch jointly form a secondary-side circuit connected to the master coil.

19. The power converter according to claim 14, wherein the battery is implemented by an aluminum-ion battery.

20. The power converter according to claim 14, wherein the seventh switch signal and the eighth switch signal are pulse width modulation signals respectively.
